(19) United States
(12) Patent Application Publication
(10) Pub. No.: US 2025/0311882 A1
(43) Pub. Date: Oct. 9, 2025

(54) Device, Beverage Maker, And Method For Dosing Solid And/Or Liquid Substances

(71) Applicant: WMF GmbH, Geislingen An Der Steige (DE)

(72) Inventors: Denis Oberhansl, Giengen An Der Brenz (DE); Stephan Joos, Geislingen An Der Türkheim (DE)

(73) Assignee: WMF GmbH, Geislingen An Der Steige (DE)

(21) Appl. No.: 19/098,388

(22) Filed: Apr. 2, 2025

(30) Foreign Application Priority Data
Apr. 3, 2024 (DE) 10 2024 203 070.8

(51) Int. Cl. A47J 31/52; A47J 31/40; G01F 23/284

(52) U.S. Cl. CPC A47J 31/525; A47J 31/402; A47J 31/404; G01F 23/284

(57) ABSTRACT

A device for dosing solid and/or liquid substances includes a container to hold solid and/or liquid substances in an interior space of the container. The container has at least one side wall, at least one base wall, and at least one outlet opening. The device also includes a dosing unit to dose solid and/or liquid substances contained in the container from the outlet opening, and a sensor arranged in the exterior space to detect electromagnetic radiation. The sensor is located in a region above the base wall and opposite a transparent part of the side wall. The device is configured to enable an empty signal from the device's container to be detected more reliably and a drink to be completely dosed, even upon receiving an empty signal. A beverage maker and a method are additionally provided.

Provided here is a device for dosing solid and/or liquid substances, which comprises a container to hold solid and/or liquid substances in an interior space of the container, the container having at least one side wall, at least one base wall and at least one outlet opening. Furthermore, the device comprises a dosing unit for dosing solid and/or liquid substances contained in the container from the container's outlet opening, and a sensor arranged in the container's exterior space for detecting electromagnetic radiation. The sensor is located in a region above the container's base wall and opposite a transparent part of the container's side wall. The device enables an empty signal from the device's container to be detected more reliably and a drink to be completely dosed to the end, even upon receiving an empty signal. A beverage maker and a method are additionally provided.

There are beverage makers in which a beverage is essentially prepared by adding a powder, a granulate or a liquid (i.e. a substrate). These so-called beverage dispensers differ from fully automatic coffee makers in that no brewing process is necessarily required to produce the beverages. For example, the beverage dispenser may hold in a storage container a solid or liquid substrate that only needs to be mixed with a liquid (e.g. water) to prepare a beverage (e.g. a cocoa powder or beverage syrup). The beverage dispenser typically also has a dosing unit, for example a feed screw arranged at the lower part of the storage container in the beverage dispenser. The dosing unit is configured to supply the substrate with a liquid (e.g. hot or cold water) through an outlet opening in the beverage dispenser's storage tank and then to mix it homogeneously with the liquid.

U.S. Pat. No. 4,665,808 A discloses a coffee machine with a container that is equipped with a means to detect the filling level of the coffee substrate within. This means includes an electro-optical sensor attached to the container's exterior over a corner formed by parts of a side wall and a base wall. For the electro-optical sensor, the transmitter (emitter) and a receiver (sensor) are arranged along an optical axis essentially extending diagonally across the corner through the container's interior, whereby the side wall and the bottom wall are optically transparent at least at the points where the optical axis passes through them. In this case, the receiver (sensor) is arranged opposite a base wall in the container. As residual amounts of the coffee substrate often remain in the bottom area, the disadvantage of this arrangement is that it cannot always reliably detect an empty signal from the container. Furthermore, arranging the sensor such has the disadvantage that an empty signal only occurs when there is no residual amount of coffee substrate left in the container, which does not guarantee that a coffee beverage can still be fully dispensed.

On this basis, the object of the present invention was to provide a device, a beverage maker and a method for dosing solid and/or liquid substances that overcomes at least one disadvantage of the prior art. In particular, it should be possible with the device, the beverage maker and/or the method to detect an empty signal of a storage container of a device for dosing solid and/or liquid substances in a more reliable manner. Furthermore, the device, beverage maker and/or method should enable a beverage to be fully dispensed to the end, even upon receiving an empty signal.

The object is achieved by the device having the features of claim 1, the beverage maker having the features of claim 14 and the method having the features of claim 15. The dependent claims show advantageous further embodiments.

According to the invention, a device for dosing solid and/or liquid substances, which are suitable for the preparation of a beverage, is provided, comprising or consisting of
a) a container to hold solid and/or liquid substances, which are suitable for the preparation of a beverage, in an interior space of the container, the container having at least one side wall, at least one base wall, and at least one outlet opening;
b) a dosing unit which is configured to dose solid and/or liquid substances contained in the container from the container's outlet opening;
c) a sensor which is configured to detect electromagnetic radiation, wherein the sensor is arranged in an exterior space of the container;
characterised in that the sensor is arranged in a region above the container's base wall and is arranged opposite a part of the container's side wall, wherein said part of the container's side wall is transparent to the electromagnetic radiation which the sensor is configured to detect.

The advantage of placing the sensor in a region above the container's base wall (instead of on the container's base wall or at a location on the container's side wall that is not at a distance from the base wall) is that a beverage can still be fully dispensed even upon receiving an empty signal. The reason for this is that the sensor already issues an empty signal when there is still a certain amount of solid and/or liquid substances, which are suitable for the preparation of a beverage, in the container.

The term “a region above the container's base wall” refers to a location in the container's exterior space that is a certain distance away from an (imaginary) surface which is spanned by the container's base wall and which faces an interior space of the container. The shortest distance between the sensor and this surface can be at least 1%, preferably at least 2%, optionally at least 3%, of the height of the container's side wall (e.g. at least 0.3 cm, preferably at least 0.7 cm, optionally at least 1 cm). The height of the container's side wall is understood to be the length of the container's side wall in a direction parallel to the container's side wall and perpendicular to the container's base wall. A minimum distance in this range can ensure that a drink can be fully dispensed, even upon receiving an empty signal. Furthermore, the shortest distance between the sensor and this surface can be a maximum of 50%, preferably a maximum of 40%, optionally a maximum of 35%, of the height of the container's side wall (e.g. maximum 17 cm, preferably maximum 14 cm, optionally maximum 12 cm). A maximum distance in this range can ensure that a minimum filling level is detected more reliably.

The advantage of the sensor being arranged opposite the part of the container's side wall (instead of being arranged opposite a base wall of the container) is that it enables an empty signal from the container to the device to be detected more reliably. This is because, while the device is in operation, dust and also solid and/or liquid substances, which are suitable for the preparation of a beverage, can collect in the area of the container's base wall and thus cover the sensor's detection surface, whereby the sensor's detection reliability can deteriorate with time. This can be avoided by placing the sensor opposite a part of the container's side wall.

The benefit of the device according to the invention is that it does not require an emitter to provide electromagnetic radiation for a detection by the sensor. In other words, for the device according to the invention, ambient light entering the container's interior space through a transparent top wall in the container, for example, can provide electromagnetic radiation that can be detected by the device's sensor. This makes the device more cost-effective to provide and reduces the device's power consumption, enabling it to be operated more economically.

According to the invention, the device's sensor can be the only sensor in the device which is configured to detect electromagnetic radiation (and is arranged in an exterior space of the container). This embodiment has the advantage that the device can be provided very cost-effectively.

In a preferred embodiment of the device, the sensor is not connected to the container in the device (i.e., the sensor is connected only to a part of the device that is not the container). The advantage of this is that the container can be removed from the device without the sensor. This minimises the risk of damaging the sensor, which increases the device's long-term stability. In addition, the container can be made more compact in size and thus more practical for the user to handle.

In another preferred embodiment of the device, the sensor extends from the region above the container's base wall to a region below an upper end of the at least one of the container's side wall (or below a top wall of the container). The term “a region below an upper end of the container's at least one side wall” refers to a location in the container's exterior space that is a certain distance away from an (imaginary) surface that is stretched by the upper end of the at least one side wall (or is spanned by the container's top wall) and that faces an interior space of the container. The shortest distance from the sensor to this upper (imaginary) surface can then be a maximum of 10%, preferably a maximum of 5%, optionally a maximum of 2%, of the height of the container's side wall (e.g. maximum 4 cm, preferably maximum 2 cm, optionally maximum 1 cm). A minimum distance in this range can ensure that the container's filling level can be quantified with maximum accuracy.

The sensor of the device may be configured to detect electromagnetic radiation having a wavelength ranging from 100 nm to 1 mm. Detection can occur, for example, in the IR range (>800 nm to 1 mm), in the VIS range (400 nm to 800 nm) or in the UV range (100 nm to <400 nm). Furthermore, the sensor can be configured to convert electromagnetic radiation into an electrical voltage signal. In this case, the sensor preferably comprises a sensor or consists of a sensor that is selected from the group consisting of a solar cell, a light-alterable electrical resistance sensor and combinations thereof. The sensor preferably comprises or consists of a solar cell, as this will allow the device to operate with lower power consumption (i.e., more economically).

The sensor may be arranged in a housing that is configured to shield the sensor from any electromagnetic radiation which is present in the container's exterior space and has a wavelength ranging from 100 nm to 1 mm. The advantage of this is that the sensor can detect electromagnetic radiation present in the container's interior space with greater reliability, thus increasing the specificity in the detection of the container's filling level.

The sensor housing can be in contact with the container's side wall, preferably such that no electromagnetic radiation having a wavelength ranging from 100 nm to 1 mm can pass from the container's exterior space to the sensor. The advantage of this is that the sensor can detect only the electromagnetic radiation which is present in the container's interior space, which maximises specificity in the detection of the container's filling level.

Furthermore, the sensor housing may be made of an elastic material that makes contact with the container's side wall, preferably such that no electromagnetic radiation having a wavelength ranging from 100 nm to 1 mm can pass from the container's exterior space to the sensor. The elastic material preferably comprises or consists of an elastomer, in particular silicone. The advantage of the elastic material is that even after the container has been removed from and reinserted into the device several times, it is ensured that the sensor's housing and the container's side wall remain in close contact.

The device's container can have a top wall that is transparent to electromagnetic radiation, which the sensor, optionally also a second and/or third sensor in the device, is configured to detect. The advantage of this is that electromagnetic radiation (e.g., light) from the container's exterior space can penetrate the transparent top wall into the container's interior space and be detected by the sensor in the device. Consequently, an emitter as a source of electromagnetic radiation can be unnecessary, whereby the device can be provided more cost-effectively and operated more economically. Accordingly, the side wall of the container of the device, optionally also the base wall of the container of the device, can be configured to be transparent to electromagnetic radiation which can be detected by the sensor, optionally also by a second and/or third sensor of the device. This can further increase the amount of electromagnetic radiation in the container's interior space and thus also its detection sensitivity and detection precision.

Furthermore, the device's container can have a top wall with a filling opening. The container in the device can also have a lid that is configured to (reversibly) close the filling opening. This has the advantage that a (re-)filling of the container of the device can be effected simply and practically.

Alternatively, it is possible that the container of the device does not have a top wall (i.e. in a region in the container's upper area, the container's side wall marks the end of the container). This embodiment is not only cost-effective to produce, but also allows for a quick and easy (re)filling of the container.

In an optional embodiment, the container in the device has no corners (e.g. in the area of the base wall). This can result in the container having a higher mechanical stability (e.g. in the area of the base wall).

The container in the device may comprise or consist of a material selected from the group consisting of glass, plastic, ceramic and combinations thereof.

In a further optional embodiment, the device lacks a component for cleaning the portion of the container's side wall which is opposite the device's sensor (e.g., there is no wiper).

The device's dosing unit can be selected from the group consisting of a feed screw, a valve, and combinations thereof. A feed screw can dispense solid and/or liquid substances appropriately. The valve is primarily suitable for dosing liquid substances.

The device may comprise a second sensor configured to detect electromagnetic radiation, wherein the second sensor is arranged in an exterior space of the container and is arranged opposite a part of the container's side wall that is transparent to the electromagnetic radiation which the sensor is configured to detect. The advantage of a second sensor is that the detection of an empty level of the container is more reliable. Another advantage is that the filling level can be detected more accurately at different heights of the container (i.e. the filling level can be categorised into two levels).

In a preferred embodiment of the device, the second sensor is not connected to the device's container (i.e., the second sensor is connected only to a part of the device that is not the container). The advantage of this is that the container can be removed from the device independently of the second sensor. This minimises the risk of damaging the second sensor, which increases the device's long-term stability. In addition, the container can be made more compact in size and thus more practical for the user to handle.

The second sensor may be configured to detect electromagnetic radiation having a wavelength ranging from 100 nm to 1 mm. Detection can occur, for example, in the IR range, in the UV range or in the VIS range.

Furthermore, the second sensor can be configured to convert electromagnetic radiation into an electrical voltage signal. In this case, the second sensor preferably comprises a sensor or consists of a sensor selected from the group consisting of a solar cell, a light-alterable electrical resistance sensor and combinations thereof. Preferably, the second sensor comprises or consists of a solar cell, as the device can thus be operated with less power consumption (i.e. more economically).

The shortest distance between the second sensor and the container's base wall is preferably greater than the shortest distance between the sensor and the container's base wall, in a direction parallel to the container's side wall. In other words, the second sensor is located at a higher position at the container than the first sensor. This has the added advantage that it enables the amount of solid and/or liquid substances in the container to be quantified.

The second sensor may be arranged in a housing that is configured to shield the second sensor from electromagnetic radiation which is present in the container's exterior space and has a wavelength ranging from 100 nm to 1 mm. The advantage of this is that the second sensor can more reliably detect any electromagnetic radiation present in the container's interior space, thus increasing the detection specificity of the container's filling level.

The housing of the second sensor can make contact with the container's side wall, preferably such that no electromagnetic radiation having a wavelength ranging from 100 nm to 1 mm can pass from the container's exterior space to the second sensor. The advantage of this is that the second sensor can detect only the electromagnetic radiation present in the container's interior space, thus maximising specificity in detecting the container's filling level.

Furthermore, the housing of the second sensor can have an elastic material that makes contact the container's side wall, preferably such that no electromagnetic radiation having a wavelength ranging from 100 nm to 1 mm can pass from the container's exterior space to the second sensor. The elastic material preferably comprises or consists of an elastomer, in particular silicone. The advantage of the elastic material is that even after the container has been removed from and reinserted into the device several times, it is ensured that the housing of the second sensor as well as the container's side wall remain in close contact.

The device can also comprise a third sensor configured to detect electromagnetic radiation, wherein the third sensor is arranged in an exterior space of the container and is arranged opposite a part of the container's side wall that is transparent to the electromagnetic radiation that the sensor is configured to detect. The advantage of a third sensor is that the detection of an empty level of the container is even more reliable. Another advantage is that the container's filling level can be detected more accurately at different heights (i.e. the filling level can be categorised into three stages).

In a preferred embodiment of the device, the third sensor is not connected to the device's container (i.e., the third sensor is connected only to a part of the device that is not the container). The advantage of this is that the container can be removed from the device independently of the third sensor. This minimises the risk of damaging the third sensor, which increases the device's long-term stability. In addition, the container can be made more compact in size and thus more practical for the user to handle.

The third sensor may be configured to detect electromagnetic radiation having a wavelength ranging from 100 nm to 1 mm. Detection can occur, for example, in the IR range, in the UV range or in the VIS range.

Furthermore, the third sensor can be configured to convert electromagnetic radiation into an electrical voltage signal. In this case, the third sensor preferably comprises a sensor or consists of a sensor that is selected from the group consisting of a solar cell, a light-alterable electrical resistance sensor and combinations thereof. The third sensor preferably comprises or consists of a solar cell, as this will allow the device to operate with less power consumption (i.e., more economically).

The shortest distance between the third sensor and the container's base wall is greater than the shortest distance between the second sensor and the container's base wall in a direction parallel to the container's side wall. In other words, the third sensor is arranged at a higher position on the container than the second sensor (and the first sensor). This has the additional advantage that the amount of solid and/or liquid substances in the container can be quantified even more precisely (in finer gradations).

The third sensor may be arranged in a housing that is configured to shield the third sensor from any electromagnetic radiation which is present in the container's exterior space and has a wavelength ranging from 100 nm to 1 mm. The advantage of this is that the third sensor can detect electromagnetic radiation present in the container's interior space with greater reliability, thus increasing specificity in detecting the container's filling level.

The housing of the third sensor can make contact with the container's side wall, preferably in such a way that no electromagnetic radiation having a wavelength ranging from 100 nm to 1 mm can pass from the container's exterior space to the third sensor. The advantage of this is that the third sensor can detect only the electromagnetic radiation present in the container's interior space, thus maximising specificity in detecting the container's filling level.

Furthermore, the housing of the third sensor can have an elastic material that makes contact with the container's side wall, preferably such that no electromagnetic radiation having a wavelength ranging from 100 nm to 1 mm can pass from the container's exterior space to the third sensor. The elastic material preferably comprises or consists of an elastomer, in particular silicone. The advantage of the elastic material is that even after the container's removal from the device and reinsertion into the device several times, it ensures that the housing of the third sensor remains in close contact with the container's side wall.

In an optional embodiment, the device according to the invention does not comprise an emitter configured to emit electromagnetic radiation into the container's interior space. This makes the device more cost-effective to provide and reduces the device's power consumption.

Alternatively, the device may have an emitter that is configured to emit electromagnetic radiation into the container's interior space. The advantage of the emitter is that even in the case of low-intensity electromagnetic radiation (e.g. visible light, UV radiation and/or IR radiation) in the surrounding area of the container, a reliable detection by the sensor, optionally also by a second and/or third sensor of the device, can be ensured. Another advantage is that the container's filling level can be detected more accurately at different heights, because the emitter can increase the total amount of radiation inside the container, especially when the intensity of electromagnetic radiation in the surrounding area of the container is weak and/or cannot, or can only weakly, penetrate into container's interior space.

The emitter can be arranged in an exterior space of the container, preferably arranged opposite a part of the container's side wall that is transparent to the electromagnetic radiation which the emitter is configured to emit.

In a preferred embodiment of the device, the emitter is not connected to the device's container (i.e., the emitter is connected only to a part of the device that is not the container). The advantage of this is that the container can be removed from the device independently of the emitter. This minimises the risk of damaging the emitter, thus increasing the device's long-term stability. In addition, the container can be made more compact in size and thus more practical for the user to handle.

The emitter may be configured to emit electromagnetic radiation having a wavelength ranging from 100 nm to 1 mm. Radiation can, for example, occur in the IR range, in the VIS range and/or in the UV range. A suitability of the emitter to emit in the UV range is connected to the advantage that the emitter also has an antiseptic effect, i.e. can disinfect the interior space of the device's container.

The emitter may comprise or consist of an emitter selected from the group consisting of an LED, laser, incandescent lamp, gas discharge lamp, and combinations thereof. The emitter preferably comprises an LED (or an LED array) or consists thereof. An LED (or an LED array) is preferred because an LED has a very low energy consumption in relation to its radiation intensity and is also cost-effective and durable. This enables an economical operation of the device.

The emitter can be arranged in the device such that it is configured to emit electromagnetic radiation directly onto the sensor. This embodiment is advantageous if the container's walls show little or no reflection of the electromagnetic radiation emitted by the emitter.

Alternatively, the emitter can be arranged in the device such that it is configured to emit electromagnetic radiation onto the sensor only by reflection in the container's interior space. This form of embodiment is advantageous if the container's walls reflect the electromagnetic radiation emitted by the emitter, because then there is more leeway for arranging the emitter in the device. In this case, it is preferred that at least some areas of the container's side wall comprise a coating which is configured to reflect the electromagnetic radiation emitted by the emitter into the container's interior space. This can, for example, be a coating that reflects electromagnetic radiation in the IR range and/or a coating that reflects electromagnetic radiation in the VIS range. However, the container does not necessarily have to comprise such a coating, because a reflection in the container's interior space can also be caused by a solid and/or liquid substance present in the container (e.g. a substance powder, such as coffee powder).

The shortest distance between the emitter and the container's base wall, in a direction parallel to the container's side wall, can be the same as the shortest distance between the sensor and the container's base wall, in a direction parallel to the container's side wall. This embodiment is advantageous if the container's walls show little or no reflection of the electromagnetic radiation emitted by the emitter.

Alternatively, the shortest distance between the emitter and the container's base wall, in a direction parallel to the container's side wall, may be greater than the shortest distance between the sensor (optionally also a second and/or third sensor of the device) and the container's base wall, in a direction parallel to the container's side wall. The advantage of this embodiment is that the emitter is located higher than the sensor (optionally also as a second and/or third sensor of the device) in the device's container and thus allows a radiation through solid and/or liquid materials in the container from top to bottom. Because of a reduction of the radiation intensity in dependence of the amount through which emission has occurred, a quantification of the container's filling level becomes possible. The emitter can preferably have, in a direction parallel to the container's side wall, a shortest distance from the base wall which is at least 10 cm, preferably at least 15 cm, particularly preferably at least 20 cm, very particularly preferably at least 25 cm, in particular at least 30 cm, optionally at least 35 cm. The emitter can be arranged in the area of the container's top wall, preferably at a distance of a maximum of 10 cm, preferably a maximum of 8 cm, particularly preferably a maximum of 6 cm, optionally a maximum of 4 cm, from the container's top wall (optionally above or below the container's top wall). The higher the emitter is placed in the container, the more accurate the quantification can be. The device may have a second emitter configured to emit electromagnetic radiation into the container's interior space. The advantage of a second emitter is that the container's filling level can be detected more reliably than with just a single emitter. Another advantage is that the container's filling level can be detected more accurately at different heights, as the second emitter can increase the total amount of radiation in the container's interior space.

The second emitter can be arranged in an exterior space of the container, preferably arranged opposite a part of the container's side wall which is transparent to the electromagnetic radiation that the second emitter is configured to emit.

In a preferred embodiment of the device, the second emitter is not connected to the device's container (i.e. the second emitter is only connected to a part of the device that is not the container). The advantage of this is that the container can be removed from the device without the second emitter. This minimises the risk of damaging the second emitter, thus increasing the device's long-term stability. In addition, the container can be made more compact in size and thus more practical for the user to handle.

The second emitter may be configured to emit electromagnetic radiation having a wavelength ranging from 100 nm to 1 mm. Radiation can, for example, occur in the IR range, in the VIS range and/or in the VIS range. The suitability of the second emitter to emit in the UV range is connected to the advantage that the second emitter further has an antiseptic effect, i.e. it can disinfect the interior space of the device's container.

Apart from that, the second emitter may comprise or consist of an emitter selected from the group consisting of an LED, a laser, an incandescent lamp, a gas discharge lamp, and combinations thereof. The second emitter preferably comprises an LED (or an LED array) or consists thereof. An LED (or an LED array) is preferred because the device can be operated very economically.

The second emitter can be arranged in the device such that it is configured to emit electromagnetic radiation directly onto the second sensor. This embodiment is advantageous if the container's walls show little or no reflection of the electromagnetic radiation emitted by the second emitter.

Alternatively, the second emitter can be arranged in the device such that it is configured to emit electromagnetic radiation onto the first and second sensors only by reflection in the container's interior space. This embodiment is advantageous if the container's walls reflect the electromagnetic radiation emitted by the second emitter, because then there is more leeway for arranging the second emitter in the device. In this case, it is preferred that the side wall of the container has, at least in some regions, a coating which is configured to reflect the electromagnetic radiation emitted by the second emitter into the container's interior space. For example, this can be a coating that reflects electromagnetic radiation in the IR range and/or a coating that reflects electromagnetic radiation in the VIS range. However, the container does not necessarily have to comprise such a coating, because a reflection in the container's interior space can also be caused by a solid and/or liquid substance present in the container (e.g. a substance powder, such as coffee powder).

The shortest distance between the second emitter and the container's base wall, in a direction parallel to the container's side wall, can be identical to the shortest distance between the second sensor and the container's base wall, in a direction parallel to the container's side wall. This embodiment is advantageous if the container's walls show little or no reflection of the electromagnetic radiation emitted by the second emitter.

Alternatively, the shortest distance between the emitter and the container's base wall, in a direction parallel to the container's side wall, may be greater than the shortest distance between the second sensor (optionally also the sensor and/or third sensor of the device) and the container's base wall, in a direction parallel to the container's side wall. The advantage of this embodiment is that the second emitter is located higher than the second sensor (optionally also as a second and/or third sensor of the device) in the device's container and thus allows a radiation through solid and/or liquid materials in the container from top to bottom. Because of a reduction of the radiation intensity in dependence of the amount through which emission has occurred, a quantification of the container's filling level becomes possible. Preferably, the second emitter can be at a minimum distance from the container's base wall, in a direction parallel to the container's side wall, which is at least 10 cm, preferably at least 15 cm, particularly preferably at least 20 cm, very particularly preferably at least 25 cm, in particular at least 30 cm, optionally at least 35 cm. The second emitter can be arranged in the area of the container's top wall, preferably at a distance of a maximum of 10 cm, preferably a maximum of 8 cm, particularly preferably a maximum of 6 cm, optionally a maximum of 4 cm, from the container's top wall (optionally above or below the container's top wall). The higher the second emitter is placed in the container, the more accurate the quantification can be.

The device may have a third emitter that is configured to emit electromagnetic radiation into the container's interior space. The advantage of a third emitter is that the container's filling level can be detected with greater reliability than with just two emitters. Another advantage is that the container's filling level can be detected more accurately at different heights, as the third emitter can increase the total amount of radiation in the container's interior space.

The third emitter can be arranged in an exterior space of the container, preferably arranged opposite a part of the container's side wall that is transparent to the electromagnetic radiation that the third emitter is configured to emit.

In a preferred embodiment of the device, the third emitter is not connected to the device's container (i.e., the third emitter is connected only to a part of the device that is not the container). The advantage of this is that the container can be removed from the device independently of the third emitter. This minimises the risk of damaging the third emitter, thus increasing the device's long-term stability. In addition, the container can be made more compact in size and thus more practical for the user to handle.

Furthermore, the third emitter may be configured to emit electromagnetic radiation having a wavelength ranging from 100 nm to 1 mm. Radiation can, for example, occur in the IR range, in the UV range and/or in the VIS range. The suitability of the third emitter to emit in the UV range has the advantage that the third emitter also has an antiseptic effect, i.e. it can disinfect the interior space of the device's container.

In addition, the third emitter may comprise or consist of a emitter selected from the group consisting of an LED, laser, incandescent lamp, gas discharge lamp, and combinations thereof. Preferably, the third emitter comprises or consists of an LED (or an LED array). An LED (or an LED array) is preferred because the device can be operated very economically.

The third emitter can be arranged in the device such that it is configured to emit electromagnetic radiation directly onto the third sensor. This embodiment is advantageous if the container walls show little or no reflection of the electromagnetic radiation emitted by the third emitter.

Alternatively, the third emitter can be arranged in the device such that it is configured to emit electromagnetic radiation onto the first, second and third sensors only via reflection in the container's interior space. This embodiment is advantageous if the container walls reflect the electromagnetic radiation emitted by the third emitter, because then there is more leeway for arranging the third emitter in the device. In this case, it is preferred if the side wall of the container has, at least in some regions, a coating which is configured to reflect the electromagnetic radiation emitted by the third emitter into the container's interior space. For example, this can be a coating that reflects electromagnetic radiation in the IR range and/or a coating that reflects electromagnetic radiation in the VIS range. However, the container does not necessarily have to comprise such a coating, because a reflection in the container's interior space can also be caused by a solid and/or liquid substance present in the container (e.g. a substance powder, such as coffee powder).

The shortest distance between the third emitter and the container's base wall, in a direction parallel to the container's side wall, can be identical to the shortest distance between the third sensor and the container's base wall, in a direction parallel to the container's side wall. This embodiment is advantageous if the container walls show little or no reflection of the electromagnetic radiation emitted by the third emitter.

Alternatively, the shortest distance between the third emitter and the container's base wall, in a direction parallel to the container's side wall, may be greater than the shortest distance between the third sensor (optionally also the sensor and/or a second sensor of the device) and the container's base wall, in a direction parallel to the container's side wall. The advantage of this embodiment is that the third emitter is located higher than the third sensor (optionally also as the sensor and/or a second sensor of the device) in the device's container and thus allows the emission of radiation through solid and/or liquid materials in the container from top to bottom. Because of a reduction of the radiation intensity in dependence of the amount through which emission has occurred, a quantification of the container's filling level becomes possible. The third emitter can preferably have a shortest distance from the base wall, in a direction parallel to the container's side wall, which is at least 10 cm, preferably at least 15 cm, particularly preferably at least 20 cm, very particularly preferably at least 25 cm, in particular at least 30 cm, optionally at least 35 cm. The second emitter can be arranged in the area of the container's top wall, preferably at a distance of a maximum of 10 cm, preferably a maximum of 8 cm, particularly preferably a maximum of 6 cm, optionally a maximum of 4 cm, from the container's top wall (optionally above or below the container's top wall). The higher the second emitter is placed in the container, the more accurate the quantification can be.

The outlet opening of the device's container can be located in the base wall or side wall of the device's container.

According to the invention, a beverage maker is provided that comprises a device according to the invention.

The device, optionally the beverage maker, may comprise an electronic circuit configured to determine the filling level of the container of the device based on signals of the sensor, preferably also based on signals from a second sensor of the device, particularly preferably also based on signals from a third sensor of the device. The electronic circuit can be a control unit. According to the invention, a method for detecting a filling level of a device for dosing solid and/or liquid substances which are suitable for the preparation of a beverage is also provided, comprising the following steps:
a) Providing a device according to the invention; and
b) Determining a filling level of the container of the device based on signals of the sensor, preferably also based on signals of a second sensor of the device, particularly preferably also based on signals of a third sensor of the device, in particular by means of an electronic circuit of the device or of a beverage maker, wherein the electronic circuit is optionally a control unit.

The subject matter according to the invention will be explained in greater detail on the basis of the following figures, without wishing to limit these to the specific embodiments presented here.

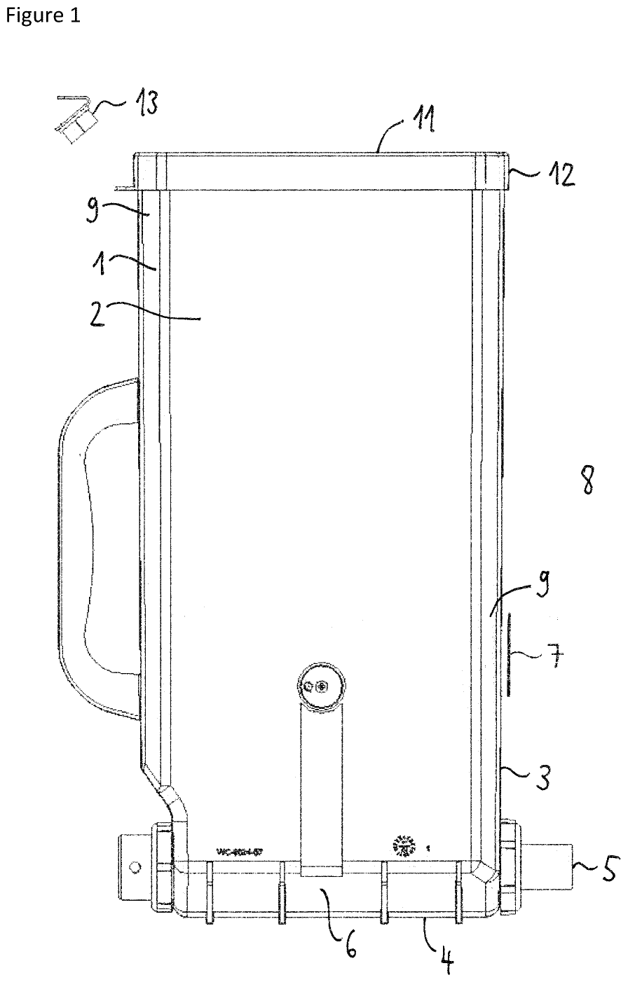

FIG. 1 shows a first device according to the invention for dosing solid and/or liquid substances that are configured for the preparation of a beverage. The device comprises a container 1 that is configured to hold solid and/or liquid substances, which are suitable for the preparation of a beverage, in an interior space 2 of the container 1. The container has at least one side wall 3, at least one base wall 4, at least one outlet opening 5 and also a top wall 11, which is formed by a lid 12 of the container 1. Furthermore, the device comprises a dosing unit 6 that is configured to dose solid and/or liquid substances contained in the container from the outlet opening 5 of the container. In addition, the device comprises a sensor 7 configured to detect electromagnetic radiation. The sensor 7 is located in an exterior space 8 of the container 1. The device is characterised in that the sensor 1 is arranged in a region above the base wall 4 of the container and opposite a part 9 of the side wall 3 of the container 1, this part 9 of the side wall of the container 1 being transparent to the electromagnetic radiation that the sensor 7 is configured to detect. The term “a region above the container's base wall” refers to a location in the exterior space 8 of the container 1 that is a certain distance away from a surface that is spanned by the container's base wall 4 and faces an interior space 2 of the container 1 (i.e. in FIG. 1, this region is located above the base wall 4). In this embodiment, the device further comprises an emitter 13 that is configured to emit electromagnetic radiation into the interior space 2 of the container 1 and also to emit directly onto the sensor 7 there.

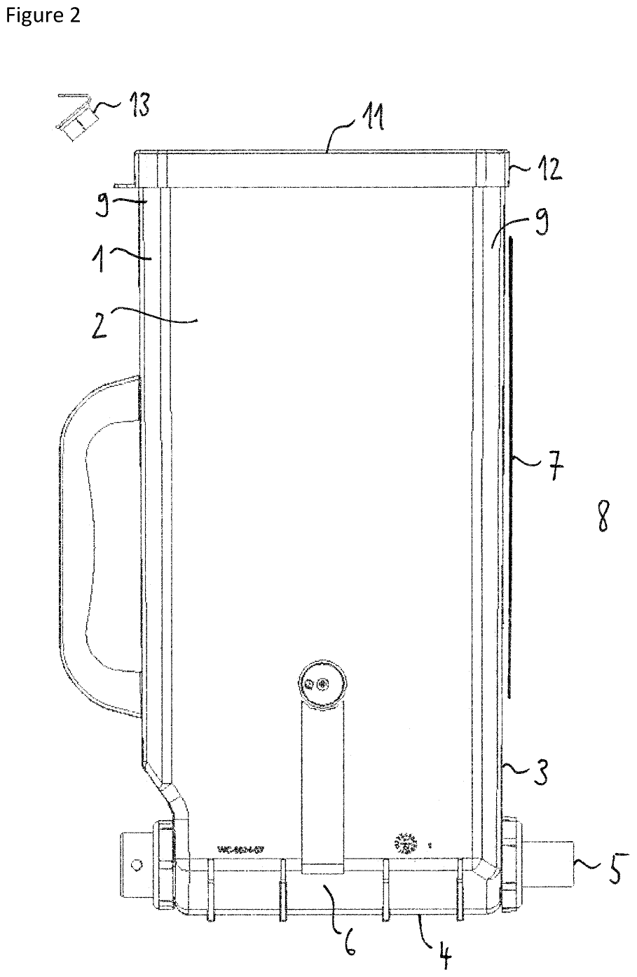

FIG. 2 shows a second device according to the invention to dose solid and/or liquid substances which are suitable for the preparation of a beverage. The second device according to the invention is identical to the first device according to the invention in FIG. 1, with the difference that the sensor 7 extends from the region above the base wall 4 of the container 1 to a region below the top wall 11 of the container 1. The advantage of such a long sensor 7 is that it enables a very accurate quantification of a filling level in the container, even if the container comprises a solid and/or liquid substance that is non-transparent to the electromagnetic radiation that can be detected by the sensor 7. The reason is that the signal intensity of sensor 7 decreases, regardless of whether or not electromagnetic radiation can pass through the solid and/or liquid substance in container 1.

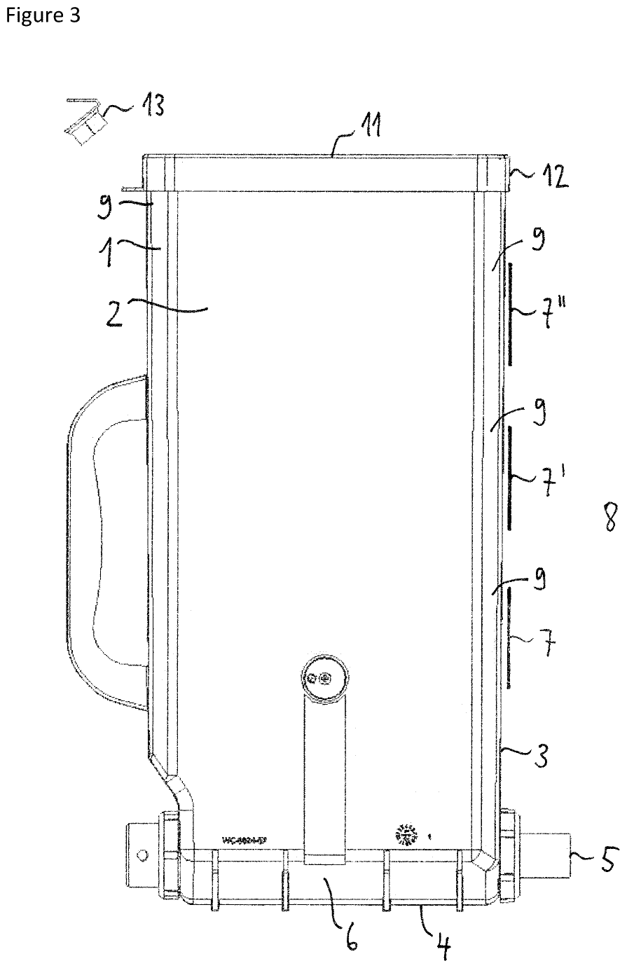

FIG. 3 shows a third device according to the invention for dosing solid and/or liquid substances which are suitable for the preparation of a beverage. The third device according to the invention is identical to the first device according to the invention in FIG. 1, with the difference that the device, in addition to the sensor 7, also comprises a second sensor 7′ and a third sensor 7″ which are each configured to detect electromagnetic radiation and are arranged in an exterior space 8 of the container 1 and are arranged opposite a part 9 of the side wall 3 of the container 1 which is transparent to the electromagnetic radiation that the respective sensor 7′, 7″ is configured to detect. The advantage of such an arrangement of three sensors 7, 7′, 7″ is that, similar to the second device according to the invention shown in FIG. 2, the container's filling level can be quantified with very high accuracy even if the container comprises a solid and/or liquid substance that is non-transparent to the electromagnetic radiation that can be detected by the sensor 7. The reason is that regardless of whether electromagnetic radiation can pass through the solid and/or liquid material in container 1 or not, the signal intensities of the third sensor 7″, the second sensor 7′ or the sensor 7 decrease as the filling level of the container decreases.

FIG. 4 shows an embodiment of a sensor 7 of a device according to the invention. In this embodiment, the sensor 7 is arranged in a housing 10 that is configured to shield the sensor 7 from electromagnetic radiation having a wavelength ranging from 100 nm to 1 mm that is present in the container's exterior space. The advantage of this is that the sensor can more reliably detect any electromagnetic radiation present in the container's interior space, thus increasing the specificity in detecting the container's filling level.

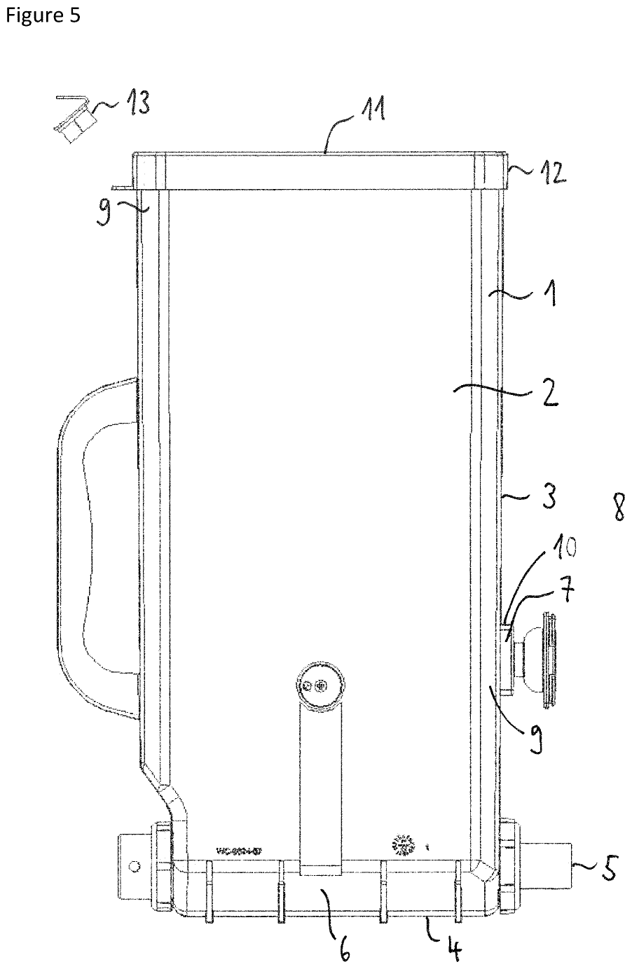

FIG. 5 shows a fourth device according to the invention for dosing solid and/or liquid substances which are suitable for the preparation of a beverage. The fourth device according to the invention is identical to the first device according to the invention in FIG. 1, with the difference that the sensor 7 is arranged in a housing 10 that is configured to shield the sensor 7 from electromagnetic radiation present in the container's exterior space and having a wavelength ranging from 100 nm to 1 mm. This increases specificity in detecting the filling level in the container 1, i.e. false reports of an empty level in the container 1 via sensor 7 can be reduced or even avoided altogether.

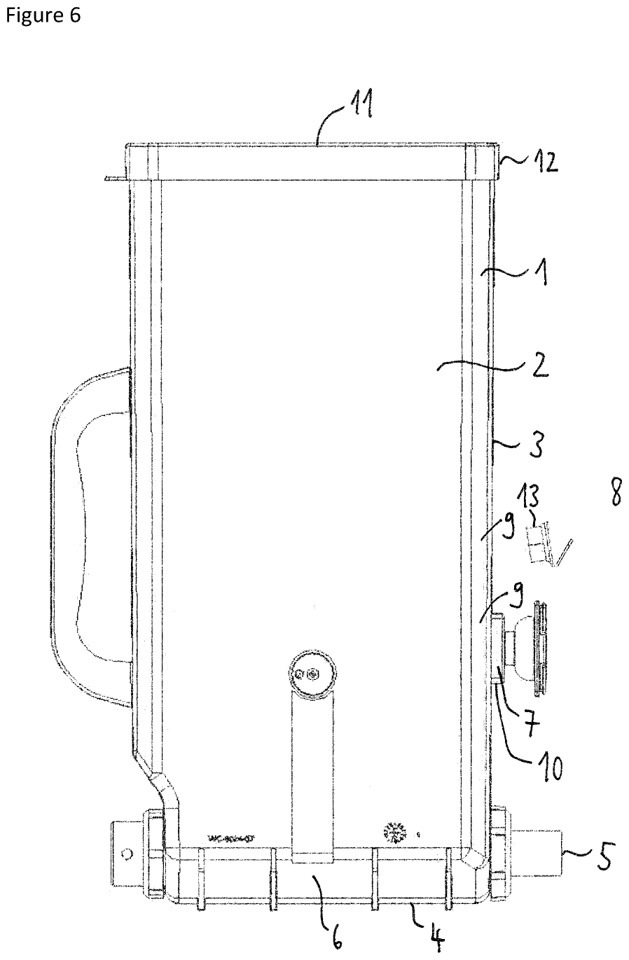

FIG. 6 shows a fifth device according to the invention for dosing solid and/or liquid substance which are suitable for the preparation of a beverage. The fifth device according to the invention is identical to the fourth device according to the invention in FIG. 5, with the difference that the emitter 13 is arranged closer and on the same side as the sensor 7 in the exterior space 8 of the container 1. In this embodiment, the emitter 13 is configured to emit electromagnetic radiation onto the sensor 7 only by reflection within the interior space 2 of the container 1. In such an embodiment, it is preferred if the side wall 3 of the container 1 has, at least in some areas, a coating that is configured to reflect the electromagnetic radiation emitted by the emitter 13 into the interior space 2 of the container 1.

### LIST OF REFERENCE SIGNS

1: container;
2: container interior space;
3 container side wall;
4: container base wall;
5: container outlet opening;
6: dosing unit;
7: sensor;
7′: second sensor;
7″: third sensor;
8: container exterior space;
9: part of the container side wall that is transparent;
10: sensor housing;
11: container top wall;
12: container lid;
13: emitter.

1. Device for dosing solid and/or liquid substances which are suitable for the preparation of a beverage, comprising or consisting of
a) a container which is configured to hold solid and/or liquid substances, which are suitable for the preparation of a beverage, in an interior space of the container, the container having at least one side wall, at least one base wall and at least one outlet opening;
b) a dosing unit which is configured to dose solid and/or liquid substances contained in the container from the outlet opening (5) of the container (1);
c) a sensor which is configured to detect electromagnetic radiation, wherein the sensor is arranged in an exterior space of the container;
wherein the sensor is arranged in a region above the base wall of the container and is arranged opposite a part of the side wall of the container, this part of the side wall of the container being transparent to the electromagnetic radiation which the sensor is configured to detect.

2. A device according to claim 1, wherein the sensor is configured to
i) detect electromagnetic radiation having a wavelength ranging from 100 nm to 1 mm; and/or
ii) convert electromagnetic radiation into an electrical voltage signal.

3. A device according to claim 1, wherein the sensor is arranged in a housing which is configured to shield the sensor from electromagnetic radiation which is present in the exterior space of the container and has a wavelength ranging from 100 nm to 1 mm.

4. A device according to claim 1, wherein the container
i) has a top wall which is transparent to an electromagnetic radiation which the sensor is configured to detect; or
ii) has no top wall.

5. A device according to claim 1, wherein the dosing unit is selected from the group consisting of a feed screw, a valve and combinations thereof.

6. A device according to claim 1, wherein the device includes a second sensor which is configured to detect electromagnetic radiation, wherein the second sensor is arranged in an exterior space of the container and is arranged opposite a part of the side wall of the container which is transparent to the electromagnetic radiation which the second sensor is configured to detect, wherein, in a direction parallel to the side wall of the container, a smallest distance between the second sensor and the base wall of the container is larger than the smallest distance between the sensor and the base wall of the container.

7. A device according to claim 6, wherein the second sensor is arranged in a housing configured to shield the second sensor from an electromagnetic radiation which is present in the exterior space of the container and has a wavelength ranging from 100 nm to 1 mm.

8. A device according to claim 1, wherein the device comprises an emitter configured to emit electromagnetic radiation into the interior space of the container, wherein the emitter
i) is arranged in an exterior space of the container; and/or
ii) is configured to emit electromagnetic radiation having a wavelength ranging from 100 nm to 1 mm, and/or
iii) comprises or consists of an emitter selected from the group consisting of LED, laser, incandescent lamp, gas discharge lamp and combinations thereof.

9. A device according to claim 8, wherein the emitter is arranged in the device such that it is configured to emit electromagnetic radiation
i) directly onto the sensor; or
ii) onto the sensor only via reflection within the interior space of the container.

10. A device according to claim 8, wherein a smallest distance between the emitter and the base wall of the container, in a direction parallel to the side wall of the container,
i) is identical to the smallest distance between the sensor and the base wall of the container, in a direction parallel to the side wall of the container; or
ii) is greater than the smallest distance between the sensor and the base wall of the container, in a direction parallel to the side wall of the container.

11. A device according to claim 8, wherein the device comprises a second emitter configured to emit electromagnetic radiation into the interior space of the container, wherein the second emitter
is arranged in an exterior space of the container; and/or
is configured to emit electromagnetic radiation having a wavelength ranging from 100 nm to 1 mm, and/or
comprises or consists of an emitter selected from the group consisting of LED, laser, incandescent lamp, gas discharge lamp and combinations thereof.

12. A device according to claim 11, wherein the second emitter is arranged in the device such that it is configured to emit electromagnetic radiation
directly onto the second sensor; or
onto the first and second sensor only via reflection within the interior space of the container.

13. A device according to claim 11, wherein a smallest distance between the second emitter and the base wall (4) of the container (1), in a direction parallel to the side wall of the container,
is identical to the smallest distance between the second sensor and the base wall of the container, in a direction parallel to the side wall of the container; or
is greater than the smallest distance between the second sensor and the base wall of the container, in a direction parallel to the side wall of the container.

14. A beverage maker, comprising a device according to claim 1, wherein the device, or the beverage maker, comprises an electronic circuit configured to detect a filling level of the container of the device based on signals from the sensor.

15. A method for detecting a filling level of a device for dosing solid and/or liquid substances which are suitable for the preparation of a beverage, comprising the following steps
a) providing a device according to claim 1; and
b) detecting a filling level of the device's container based on signals of the sensor.
